(19) United States
(12) Patent Application Publication
(10) Pub. No.: US 2024/0421510 A1
(43) Pub. Date: Dec. 19, 2024

(54) ELECTRICAL CONTACT CONNECTION

(71) Applicant: ALOTEK TECHNOLOGY LIMITED LIABILITY COMPANY, Orly Podkarpackie (PL)

(72) Inventors: Volodymyr Kozyrskyi, Kiev (UA); Ivan Tkachuk, Kiev (UA); Semen Voloshyn, Kiev (UA)

(21) Appl. No.: 18/701,519

(22) PCT Filed: Oct. 14, 2021
(86) PCT No.: PCT/BG2021/000025

§ 371 Date: Apr. 15, 2024

(51) Int. Cl. H01R 4/62; H01R 4/01; H01R 4/34

(52) U.S. Cl. CPC H01R 4/62; H01R 4/01; H01R 4/34

(57) ABSTRACT

The invention relates to an electrical contact connection, including a kit of contact connection elements, as well as to a method for stabilizing the contact resistance in the case of an electrical contact connection.

The contact connection contains current-carrying contact elements (1), a threaded joint (2) for pressing the contact surfaces of the current-carrying elements (1), a contact pressure stabilizer (4) made of an alloy with shape memory effect, as well as functional lubricant (6), for application on the contact surfaces of the conductive elements (1), which is a mixture of plastic gel (8) with added microparticles (9) of an alloy with a shape memory effect.

### FIELD OF THE INVENTION

The invention relates to an electrical contact connection, including a kit of contact connection elements, as well as to a method for stabilizing the contact resistance of electrical contact connections. The contact connection is applicable in the electric power, oil and gas industry, metallurgy, mining, chemical and other branches of industry, transport, electrical supply network and traction power supply systems for use in substations, power distribution and switching equipment and other electrical installations. It serves to receive, convert and distribute electricity in networks in the voltage range up to 1000 kV and higher, as well as in the field of installation, repair and maintenance of electrical equipment.

The invention is directed to reducing the transient resistance of detachable electrical contact connections, stabilizing the resistance value, and to the possibility of direct connection of contact parts of copper, aluminum and their alloys, both in terms of installation, repair and maintenance of existing energy facilities, as well as for use in enterprises producing electrical equipment using functional intermetallics.

### BACKGROUND OF THE INVENTION

The key function of electrical contact connections is to create conditions for the flow of current through certain parts of the circuit by direct contact and tightening of specially formed conductors, with minimal losses and within the required time interval. The trouble-free operation of electrical wires and electrical equipment depends on the condition of the electrical contact connections. During operation, the contact connections are periodically heated and cooled by varying in time currents. The processes of heating and cooling the contact connections lead to mechanical stresses in the contact parts, to accumulation of residual deformation, to reduction of the contact pressure, to an increase of the transient resistance and further to a heat increase at the same load currents. The process of overheating the contacts during prolonged operation is natural and objective from a physical point of view and can be changed only with additional means. Contact connections are the weakest parts of electrical systems. The main reason for their diminished reliability is the increased contact resistance between the elements of the connection. Undesirable layers formed on the contact surface create excess electrical resistance, which can lead to damage of the contact system. Atmosphere humidity also affects the contact surface. Oxides, sulfides and other surface pollutants have higher electrical resistances than base metals. The high contact resistance between the contact elements causes an uneven distribution of electric currents in the two parts, leading to large power losses at the contact ends, and therefore to an increase in temperature of the contact connection. It is found that the highest energy losses are at the area of connection at the ends of the contacts, where the contact temperature rises. It is this higher temperature that leads to an increase in the contact resistance at the ends of the contacts.

Many factors affect the quality and life of contact connections. Contamination with dust, humidity, coatings, current harmonics, accidental malfunctions in exploitation and higher temperatures are the main such factors. The electrical current capacity of the splint load is determined by the maximum temperature for which the splint is designed. This upper operating temperature limit is important because at the maximum operating temperature the velocity of surface oxidation of the contact materials in the air environment increases rapidly, which in the long run can lead to local overheating of the connection. A way to improve the operation of the connection is to increase the contact surface. A constructive increase in the length of the connection in order is known to increase the heat transfer to the environment, but above certain dimensions this does not affect the operation of the electrical connection. Another very important factor for the reliability of the contact connection is the contact force of pressure, which depends on the type of material and its hardness. Increasing the contact force of pressure leads to a decrease in the contact resistance, and hence to a decrease in temperature, but it is not desirable to exceed the specified value of the contact pressure, as it will mechanically damage the elements of the connection, and as a result will also lead to rising contact resistance.

In electrical networks and electrical equipment, a large number of contact connections of different kinds and types are used. The most common of these are detachable screw-on or twist-on electrical contact connections. The efficient operation of electrical networks and electrical equipment largely depends on the reliability and efficiency of multiple detachable screw-on or twist-on electrical contact connections connecting individual sections of electrical networks.

A problem in the operation of the detachable contact connections affecting the reliability and efficiency of electrical networks and electrical equipment, is the uncontrolled and uncompensated increase in transient electrical resistance, which leads to power losses, overheating of contact elements and can cause emergencies and even the occurrence of fires, circuit breakings and emergency shutdowns.

In summary, the factors that influence the increase in the transient electrical resistance and, as a consequence, the overheating of the detachable contact connections are:
weakening of the contact pressure, for example in case of self-loosening of the connection as a result of vibrations;
accumulation of residual deformation in the elements of the detachable contact connections during heating-cooling cycles, due to the use of materials with different coefficients of thermal expansion (current-carrying elements Al, Cu, etc., as well as Fe, from which material the fasteners are made—bolts, screws, nuts);
oxidation of contact surfaces, formation of dielectric oxide films due to the penetration of air and moisture into the space between the contact elements, which causes oxidative processes,
decreasing of the contact zone due to the weakening of the contact force of pressure and the oxidation processes of the contact surfaces, and others (FIG. 1).

A group of known technical solutions, such as the disclosures in patent publications RU74211 U1, U.S. Pat. No. 9,058,729B2, U.S. Pat. No. 9,748,062B2, offer only monitoring of the temperature of the detachable contact connections. The sensor elements are made in different ways, for example as flexible stickers with color reversible and non-reversible thermal indicators, as well as indicators in the form of springs made of shape memory material or paraffin-based actuator. These known devices only indicate that a contact connection temperature has risen above a predetermined value, but do not fix the time of the adverse event, nor can they alleviate the state of the connection and return it to normal operation.

There are also ways to reduce the contact voltage and provide a large effective contact surface area by applying a thin layer of electrically conductive or electrically neutral contact lubricants. Contact lubricants are known in the art, representing specially formulated greases and oils that improve the electrically conductive characteristics of electrically charged metal surfaces in switches and connectors. But these lubricants do not effectively prevent the formation of oxide layers. The process of oxidation of the contact parts takes place continuously during the operation of the electrical installations. With high humidity, aggressive environments and high temperatures of ambience, this process is much faster than under normal operating conditions.

It is known from the patent publication JP2001345017A conductive bonding layer for electronic boards, containing thermosetting or thermoplastic bonding resin in which are mixed a large number of fine conductive metal particles and two-component conductive casted metal particles containing a core in the form of bent staples or splices made from alloy with a shape memory effect, coated with another electrically conductive layer of alloy with a lower melting point. When heated during the application of the layer, the core elements straighten, stretch the shell of coated electrically conductive layer, and increase their area in contact with the fine metal particles, resulting in improved conductivity. Such a conductive layer is not applicable for contact connections in the electric power industry, because during its application the layer hardens and the connection becomes non-detachable. In addition, the harmful oxide and contaminant layers in the contact connections obtained during the operation of the joints are not destroyed.

There are ways to protect detachable electrical contact connections, but some of them only reduce the negative impact of individual factors on the technical condition of the electrical contact connections and do not guarantee their reliability.

A detachable bolted contact connection (Dzektzer N. N., Vislenev Y. S., Multiampere contact connections. L.: Energoatomizdat. Leningrad. Otd-nie, 1987, 128 p.) is known, which contains current-carrying elements having contact surfaces, a bolt with a nut and a steel spring washer for squeezing the contact surfaces of the current-carrying elements. At the beginning of the operation of the contact connection, the steel spring washer ensures that the contact pressure is maintained within the nominal values, but practice shows that the pressure created by such a washer is not directly dependent of the temperature state of the detachable contact connection. In addition, it negatively affects the conductive elements, which are made of non-ferrous metals and are much softer than spring steel.

Other detachable electrical contact connections are also known, in which the contact pressure is regulated with raising temperature. The electrical contact compounds described below are of interest. For example, the detachable contact connection of the patent publication UA79134 C2 comprises current-carrying elements having contact surfaces and a threaded joint for squeezing the contact surfaces of the current-carrying elements, in this case a bolt with a nut, a plate made of alloy with effect of shape memory, plate being placed between the contact surfaces of the contact elements, covering the entire area between the contact surfaces, which plate deforms with raising temperature and at the time of deformation the plate rubs on the contact surfaces, destroys the partially formed oxide layers, reduces the contact resistance, leading to a drop in temperature and return of the shape of the plate to its original position.

Another close contact connection, disclosed in the patent publication UA3829 (U), also comprises current-carrying elements having contact surfaces and a threaded joint for squeezing the contact surfaces of the current-carrying elements, in this case a bolt with a nut, as well as having two washers placed under the head of the bolt and the nut, which washers are made from alloy with shape memory effect. One washer has a final temperature for recovery the initial shape below the minimum ambient temperature. This washer is flat. The other washer is a spring washer with a temperature at the beginning of the recovery of the shape higher than the maximum possible ambient temperature, thus compensating for the mechanical stresses in the contact parts.

It is also known from the other patent publication RU2091932C1 an electrical contact connection, comprising current-carrying contact elements, a threaded joint, in this case a bolt with a nut, for pressing the current-carrying contact elements and at least one contact pressure stabilizer in the form of a disc spring washer connected to the bolted connection. The stabilizer is made of an alloy with an effect of superelasticy, which improves the contact pressure.

Another prior art disclosure is described in the patent publication UA57110C2. Disclosed is a contact connection comprising current-carrying contact elements, a threaded joint, in this case a bolt with a nut, for pressing the current-carrying elements, as well as at least one contact pressure stabilizer in the form of a disc spring washer connected to the bolted connection. The stabilizer is made of an alloy with a shape memory effect with an initial shape recovery temperature higher than the maximum possible ambient temperature.

The known detachable threaded contact connections cannot reduce the transient electrical resistance completely, as they rely only on the squeezing and pressing force.

To ensure the reliability and efficiency of the operation of the detachable contact connections the solution should be comprehensive, neutralizes the basic factor and allowing for the neutralization of more negative factors over a long period of time.

### SUMMARY OF THE INVENTION

It is an object of the present invention to provide an electrical contact connection with increased efficiency, reliability and durability, which provides a reduction of the transient electrical resistance, and a reduction of the total operating losses of the electrical installations.

The object of the invention is achieved by an electrical contact connection comprising at least two current-carrying elements having contact surfaces, at least one threaded connection with a threaded element and with at least one nut for squeezing and pressing the contact surfaces of the current-carrying elements. The contact connection according to the present invention also contains a lubricant for applying to the contact surface of at least one of the conductive current-carrying elements, and serving to increase the effective area of the contact surface and to neutralize the negative influence of oxidation processes on the transient electrical resistance between the contact surfaces. The lubricant is a mixture of a plastic gel-lubricant with added particles of electrically conductive alloy with the effect of shape memory, which particles have a structure with at least one of sharp tips, regions or edges. At temperatures around the ambient temperature the particles shrink and are deformed, and at temperatures above the starting temperature of material transformation the particles unfold, the sharp tips, regions and/or edges scratch and destroy the oxide and other layers of contaminants, which contaminants cause the increase of contact resistance and temperature of the connection. Unexpectedly, it has been found that when the temperature of the contact joint increases, the destruction of the undesirable layers on the contact surfaces when unfolding the added particles with sharp edges and/or edges in the lubricant leads to a faster and greater reduction of contact resistance and elongation and extend the life of the contact connection.

In a preferred embodiment the electrical contact connection further comprises at least one contact pressure stabilizer made of an alloy with a shape memory effect having the possibility of positioning to one end of the threaded element and for contact with one current-carrying element. Preferably, the stabilizer is able to contact the contact surface of a conductive element. The shape memory intermetallic stabilizer serves to regulate the tightening between the contact surfaces and is designed to maintain tight pressure at the level of the nominal value in case of accidental or systematic reduction of the contact pressure and increase of the temperature of the contact connection. The stabilizer acts on the basis of the thermodynamic properties of intermetallic materials. The stabilizer has an altered initially memorized shape and takes a close to flat planar shape when tightening the threaded joint. From time to time or periodically, as a result of adverse factors, the contact resistance between the conductive surfaces of the contact connection increases as a result of loosening of the threaded connection, or as a result of a momentary increase in current, or the formation of oxidative crust or other contaminants of the contact surfaces, as a result of which the temperature of the joint rises. As the temperature of the contact connection rises, the stabilizer smoothly regains the memorized shape, expands, reduces or eliminates gaps in the threaded connection and thus creates a reactive force leading to the maintenance of a more constant contact pressure. Unexpectedly, it has been found that when the temperature of the contact connection rises, the simultaneous application of pressure by the stabilizer and the destruction of undesirable layers on the contact surfaces caused by the unfolding of the added particles with sharp tips, regions and/or edges in the lubricant leads to much faster and much greater reduction of the contact resistance, and to respectively faster normalization of the temperature of the contact connection. Preferably the stabilizer is in the form of a conical spring washer. This increases the contact pressure as a result of the design of the stabilizer.

In another preferred embodiment, the threaded element is a bolt or headless bolt or a screw terminal connection.

In a further preferred embodiment, the electrical contact connection also comprises a spring intermetallic washer with the possibility of positioning on the other end of the threaded element and for contact with another contact surface of the conductive elements, the washer being made of an intermetallic alloy with superelasticity effect. In some cases, in the event of a sudden mechanical weakening of the contact pressure during operation, whether the temperature of the electrical connection has risen or not, the spring intermetallic washer regains its original shape as a result of the superelastic properties of the material, thus returning the contact pressure to nominal its value. This further prevents additional uncontrollable destructive processes in the connection. In a more preferred embodiment, the washer is in the form of a conical ring.

In a further preferred embodiment, the electrical contact connection also comprises at least one thermal indicator made of an alloy with a shape memory effect that can be positioned between or on the elements of the contact connection. Thermoindicators provide continuous diagnostics of the technical condition of electrical connections in real time, react to temperature thresholds and record significant exceedances of the normal temperature range for the connection. In this way, the indicators signal that the compound has been subjected to extreme stress and should be diagnosed. When the indicators are more than one and are made of materials with different transformation temperatures, if all have registered different extreme loads, this is a signal that the connection has been subjected to system overloads and a problem has arisen in the network or equipment that should be diagnosed and removed in a timely manner. Preferably, the thermal indicator is a plate which, during installation, has a flat shape at temperatures below the transformation temperature and which bends at an angle at contact connection temperatures above the transformation temperature of the alloy or having an angled shape at temperatures below the transformation temperature of the alloy and which unfolds into a flat shape at temperatures of the contact connection above the transformation temperature of the alloy. Preferably, a colored marking is applied to the plate, visible when the thermal indicator is activated.

The proposed electrical contact connection for detachable electrical contact connections according to the invention is technically feasible and compatible with the operation of various commonly used electrical devices, for example simplifies the maintenance of electrical panels, eliminating the need for routine periodic tightening of all contact connections without exception, while not increasing the size of structural and assembly units of electrical equipment.

A lubricant is further provided for an electrical contact connection, as described above, used for application to the contact surfaces of the conductive elements. It is a mixture containing a plastic gel-lubricant having evenly distributed added particles of shape memory alloy, which have a structure with sharp tips, regions and/or edges. The lubricant provides better contact by filling in the micro-irregularities, which increases the contact area, seals the contact space and stops the access of air and moisture. At the same time, with periodic heating of the contact and with sufficient contact pressure, the sharp tips, regions and/or edges of the added particles scratch the contact surface and destroy the layer of oxides and contaminants on it, which provides stabilization of the transient electrical resistance. The mechanism of destruction of the contaminant layer is based on the thermodynamic properties of the added alloy particles with the effect of shape memory, which under the action of temperature shift relative to the contact surfaces, scratch and destroy the contaminated layer. Since the formation of an oxide layer on the transmitting surfaces has the greatest influence on the values of the transient electrical resistance between the contact surfaces, the use of the functional lubricant as described herein slows down the chemical aging of the contact surfaces. The use of the functional lubricant according to the invention in electrical contact connections makes it possible to directly connect parts of the joint made of homogeneous and different conductive materials, including the connection of aluminum rails with copper contact parts. In one preferred embodiment the amount of particles of the shape memory alloy added to the above lubricant is in range of 7-15%. In another preferred embodiment the particle size is about 10 μm.

The invention also relates to a kit of parts for the described electrical contact connection, comprising at least one threaded element with at least one nut for forming a threaded connection, at least one contact pressure stabilizer and at least one item containing a lubricant having the above described characteristics are placed.

In a preferred embodiment, the kit of parts for the electrical contact connection also comprises at least one spring intermetallic washer with the possibility of positioning on the threaded element and for contact with the contact surface of the conductive elements, which washer is made of superelastic alloy.

The kit may also contain at least one thermal indicator, which is a plate made of an intermetallic compound with a shape memory effect. The thermal indicator is a plate which, during installation, has a flat shape at temperatures below the transformation temperature and which bends at an angle at temperatures above the transformation temperature of the alloy or having an angled shape at installation at temperatures below the transformation temperature of the alloy and which unfolds to a flat shape at temperatures above the transformation temperature of the alloy.

The invention also relates to a transformer equipment comprising at least one electrical contact connection having the characteristics as described above.

The invention also relates to an electrical contact network for railway and/or urban transport containing at least one electrical contact connection having the characteristics as described above.

The above inventions provide transformer equipment and/or a catenary from the electrical grids that are more reliable and efficient with reduced maintenance costs.

Also disclosed is a method for stabilizing the contact resistance in a detachable electrical contact connection comprises the step of scratching one or more contaminating layers formed during operation of the contact connection on the contact surfaces by using a lubricant applied between the contact surfaces of the current-carrying elements of the contact connection. The lubricant is a mixture containing a plastic gel with added particles of an alloy with a shape memory effect and the particles of alloy with shape memory effect added to the plastic gel have a structure with at least one of sharp tips, regions or edges for scratching and destruction of contaminating layers formed during the operation of the contact connection on the contact surfaces.

In a preferred embodiment of the method it further comprises the steps of regulating the tightening between the current-carrying elements (1) of the contact connection and maintaining a tight pressure to a nominal value in case of accidental or systematic reduction of the contact pressure and increase of the temperature of the contact connection by using a spring intermetallic washer (5) made of an alloy with the effect of superelasticity having the possibility to contact with one of current-carrying elements (1) and/or by using a contact pressure stabilizer made of an alloy with a shape memory effect having the possibility to contact with the other current-carrying element (1).

### BRIEF DESCRIPTION OF THE DRAWINGS

FIG. 1 shows a diagram of the influences of the unfavorable factors on the electrical detachable connections;

FIG. 2a shows a general view of a contact connection for stabilizing the transient resistance of electrical thread connection, including a contact lubricant, a stabilizer, a spring washer and a thermal indicator made of intermetallics with a shape memory effect and a superelastic effect;

FIG. 2b shows a section of another contact connection for stabilizing the transient resistance of electrical thread connection, including contact lubricant, stabilizer and thermal indicator made of intermetallics with shape memory effect, where the thermal indicator is mounted to the bolt head;

FIG. 3a shows a top view of an exemplary design of a stabilizer and/or an intermetallic spring washer;

FIG. 3b shows a section of the exemplary construction of FIG. 3a;

FIG. 4a shows a section of a contact bolted electrical connection provided with an intermetallic stabilizer for stabilizing the contact pressure in the initial position;

FIG. 4b shows a section of the contact bolted electrical connection of FIG. 4a provided with an intermetallic stabilizer after stabilization of the contact pressure;

FIG. 4c shows the thermomechanical characteristics of the intermetallic stabilizer during cyclic heating and cooling;

FIG. 4d shows a comparative graph of the temperature change of a bolted electrical connection with and without a stabilizer with two aluminum busbars; and

FIG. 4e shows a comparative graph of the temperature change of a bolted electrical connection with and without a stabilizer with two copper busbars;

FIG. 5a shows a contact bolted electrical connection provided with an intermetallic spring washer with a superelastic effect; and

FIG. 5b shows the deformation characteristics of the intermetallic spring washer with the effect of superelasticity of FIG. 5a;

FIG. 6a shows a diagram of an enlarged section of the microstructure of the contact surfaces between which a lubricant is applied according to the invention;

FIG. 6b shows a fraction of intermetallic particles under an electron microscope;

FIG. 6c shows comparative graphs of the influence of lubricants of different contents on the transient electrical resistance between electrical contact surfaces;

FIG. 7a,c show a thermal indicator in initial position;

FIG. 7b,d show a thermal indicator in the final position;

FIG. 7e shows a color marking on intermetallic thermal indicators;

FIG. 8a,b show variants of connection by one or two cable lugs;

FIG. 9a shows a general view of a power disconnector of a power transformer with an integrated electrical contact connection according to the invention;

FIG. 9b shows a scheme of a transformer with a contact bracket; and

FIG. 9c shows a schematic transformer without a contact bracket;

FIG. 10 shows a comparative graph of the change in transient contact resistances between the contact surfaces of contact connections with intermetallic lubricant E and with prior art lubricant C;

FIG. 11 shows a comparative graph of the change in the transient contact resistance between the contact surfaces of contact connections with intermetallic stabilizer—E1, with intermetallic stabilizer and lubricant—E2 and one known from the prior art contact connection C.

### DETAILED DESCRIPTION OF THE INVENTION

The present invention is illustrated by the accompanying drawings, in which a preferred embodiment of the contact compound applicable to general use is shown.

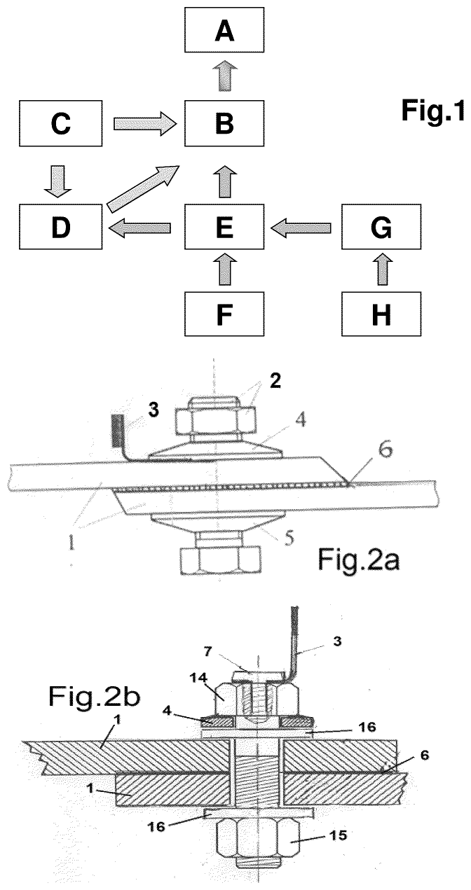

FIG. 1 illustrates the interaction and reflection of the adverse factors affecting the electrical screw detachable connections. It can be seen that the thermal wear A of the electrical threaded detachable contact connections mainly depends on the increase of the transient electrical resistance B. The resistance B increases as a result of adverse external random or systemic influences, such as oxidation C of the contact surfaces, reduction of the contact area D as a result of weakening of the contact pressure E, etc. The contact pressure E is affected by random vibrations F, which loosen the threaded connection, as well as the uneven thermal expansion of the metals G, as a result of, for example, uneven current loads H, causing temperature ripples of heating and cooling the contact connection.

FIG. 2a is a general view of a preferred embodiment of a contact connection for stabilizing the transition electrical resistance of the connection, comprising elements made of intermetallics according to the invention. In this case, a threaded joint 2 is shown connecting contact elements 1 by means of a bolt. An intermetallic temperature indicator 3 is mounted on the contact surface of the one contact element 1, on which an intermetallic stabilizer 4 is mounted. Both the temperature indicator 3 and the stabilizer 4 are made of alloy with shape memory effect. An intermetallic spring washer 5, made of alloy with an effect of superelasticity, is mounted on the contact surface of the other contact element 1

FIG. 2b shows the bolt connection 2 according to the invention and shows another variant of mounting the temperature indicator 3 on the head of the bolt from the bolt connection 2 by means of a fastening screw 7.

Between the contact surfaces of the two contact elements 1 a functional electrically conductive intermetallic lubricant 6 is applied. In the case of periodic heating of the contact surfaces as a result of electrical load or short-circuit currents, the intermetallic particles destroy the dielectric oxide layers on the contact surfaces and thus ensure stabilization of the contact electrical resistance influence. The mechanism of layer destruction is based on the thermodynamic properties of the particles of the intermetallic compound with shape memory, which under the action of temperature change their shape, move relative to the contact surface, scratch the harmful layer and thus destroy the oxide films.

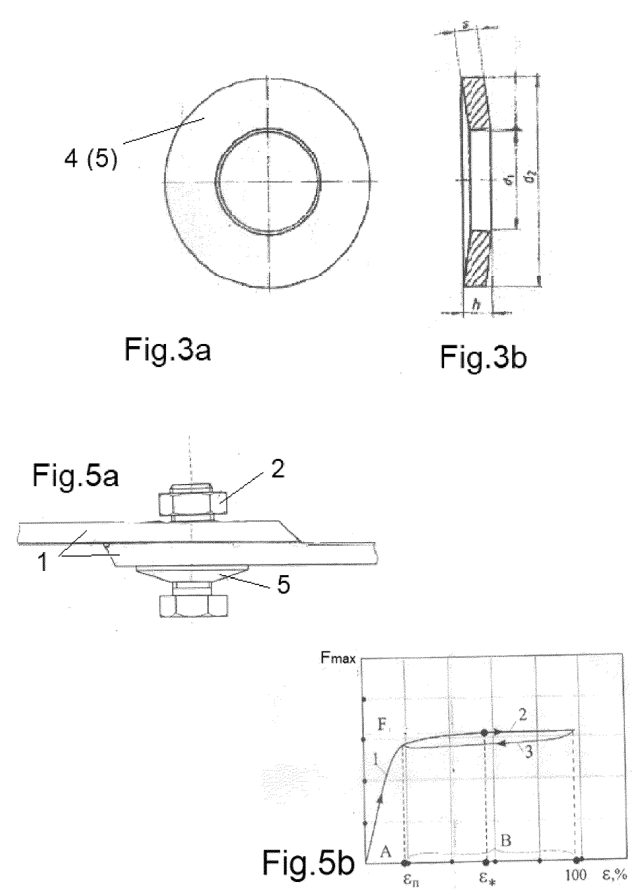

The intermetallic stabilizers 4 are made with parameters necessary for the optimization of the contact pressure for the respective standard size of the bolted connection 2. The contact pressure also depends on the construction and materials of the elements of the contact connection. For example, for threaded connection M12 and aluminum conductors, an optimal tension in the range of 40.0+/−2.0 Nm is preferred, while for copper conductors a tension in the range of 64.0+/−3.0 Nm is preferable. The stabilizer 4 and the spring washer 5 can be made in their initial shape as cone-shaped rings, as shown in FIGS. 3a,b. For example, for bolted connections 2 with M12 thread, the stabilizer 4 and the washer 5 can have an outer diameter d2 equal to 24+/−0.5 mm, an inner diameter d1 equal to 13.5+/−0.5 mm, a thickness S of the washer equal to 2.5+/−0.5 mm, and with a height of the washer h equal to 3.6+/−0.5 mm. The material of the spring washer 5 has a shape memory effect, for example a Cu-based multi-element Cu-X-Y compound, wherein Y and/or X are selected from the elements of groups II-VI of the periodic table. One exemplary composition is Cu-83.0%, Al-13.0% and Mn-4%, which at a temperature of −35° C. has the effect of shape memory, and in the temperature range above 15° C. provides the effect of superelasticity. The material of the stabilizer 4 may be, but is not limited to, a multi-element Cu-based compound such as Cu—Zn—Al, Cu—Al—Mn, Cu—Ni—Al or Cu—Al—Zn, whose memory effect of the form it manifests itself at positive temperatures, for example in the range from +15° C. to 150° C., as +40° C., where no effect of superelasticity is manifested.

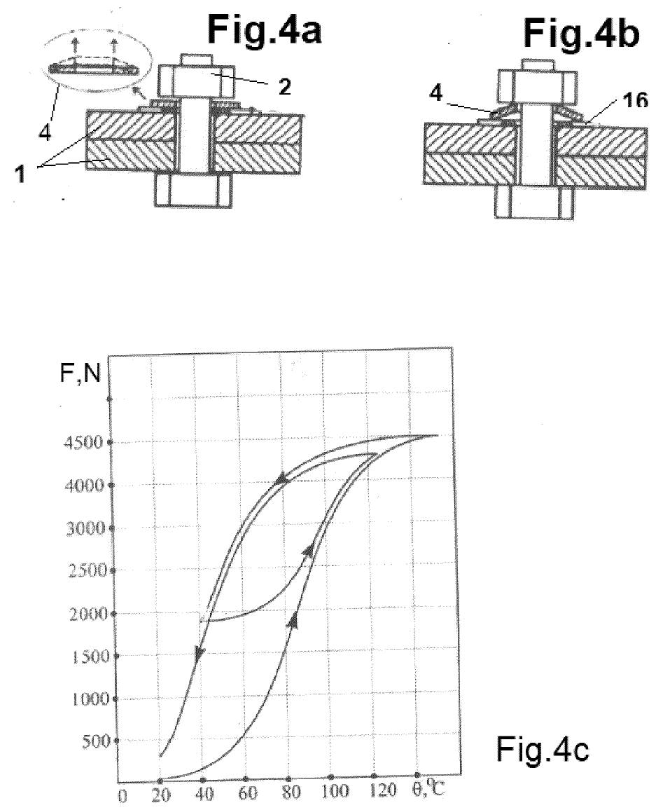

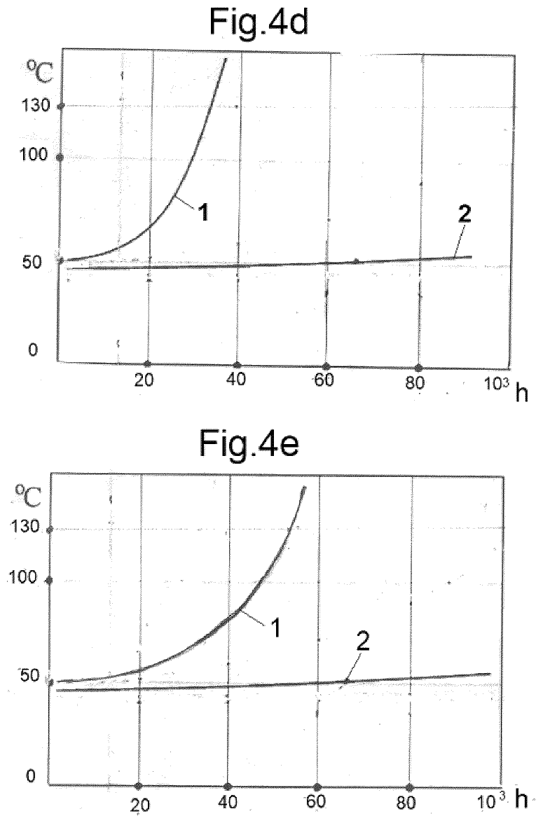

FIGS. 4a,b,c,d,e illustrate the process of stabilization of the transient electrical resistance. FIG. 4a and FIG. 4b schematically show the compensatory stage of operation of the stabilizer. At the initial moment of operation of the contact connection, or after repair works (FIG. 4a), the stabilizer 4 is bent to a flat position by the pressure of the bolted connection 2. After loosening the bolted connection for external accidental or undesirable reasons and the contact surfaces do not provide tight contact or after formation of contaminating layers due to the ambient condition, the contact area is reduced and the temperature is raised above the temperature of transformation of the material of the stabilizer 4. The stabilizer 4, made of intermatelic with the effect of shape memory, begins to return its cone-shape and the contact pressure returns to its original values (FIG. 4b). The thermo-mechanical characteristics of the intermetallic stabilizer 4, during cyclic heating and cooling, are shown in FIG. 4c. The value of the operating temperature of the stabilizer 4 depends on the functional properties of the intermetallics from which the stabilizer is made. The technology for the preparation of intermetallics with a set threshold operating temperature is described in application PCT/BG 2020/000017. For example, intermetallic stabilizers can easily be made to be with the operating temperature (−10), 30, 50° C. or other values. FIG. 4d shows comparative graphs of temperature change during operation of a threaded contact connection between two aluminum rails, and FIG. 4e shows comparative graphs between two copper rails, respectively graph (1) without and graph (2) with a stabilizer according to the invention.

Similarly, FIG. 5a illustrates a bolted electrical connection according to the invention provided with a spring washer 5 of intermetallics with a superelastic effect, and FIG. 5b shows the deformation characteristics of the washer 5. In this case, the washer 5 is designed as a conical ring as described above and shown in FIG. 3. As can be seen in FIG. 5b by the deformation characteristics, the spring washer 5 made of intermetallic alloy with a shape memory effect provides stabilization of the contact pressure in a wide range of deformation.

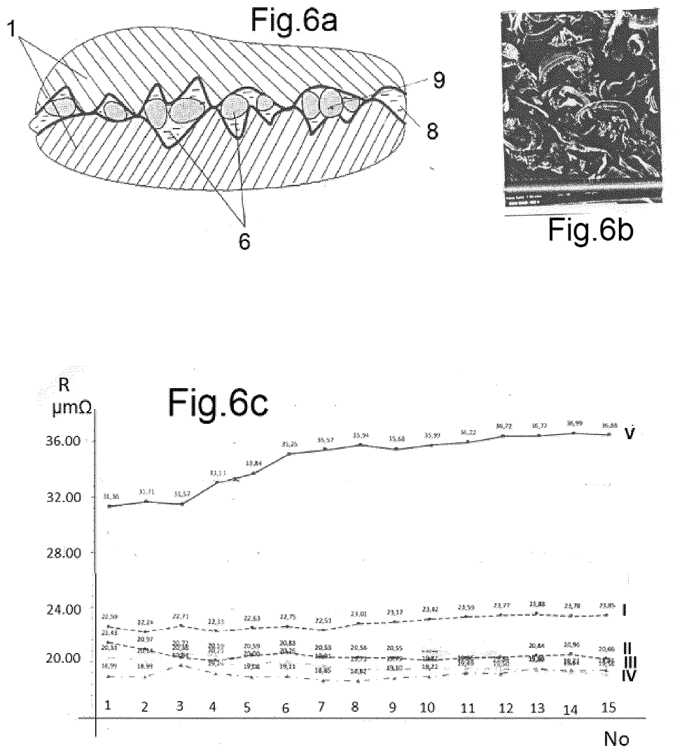

The lubricant 6 applied between the contact surfaces, as illustrated in FIG. 6a, is a mixture of gel-lubricant binder 8, in which intermetallic powder particles 9 are evenly dispersed. The applied layer of functional lubricant 6 is of orderliness of 0.2-0.3 mm. FIG. 6b shows a part of the field of view of an electron microscope, where the powder particles 9 are observed, representing a very fine fraction of intermetallic particles, for example very small shavings or cuttings obtained from an intermetallic alloy with a shape memory effect. Preferably, the plastic gel lubricant 8 is a contact neutral lubricant such as SOLIDOL, CIATIM, etc., and the added intermetallic particles 9 are in an amount in the range of 7-15% and a particle size of about 10 μm. The particles 9 in this case are obtained by scraping a piece of intermetallic material using diamond powder abrasive tools, but can be obtained in any other manner known in the art. The transformation temperature of the added intermetallic particles is, for example, in the range of about 50° C. to about 60° C. An optimal volume ratio of 90%:10% between the amount of gel lubricant 8 and the intermetallic particles 9 was found experimentally. The service life of the contact lubricant 6 is about 12 months.

FIG. 6c illustrates comparative graphs of the influence of lubricants of different contents on the transient electrical resistance between electrical contact surfaces. Curves I-IV show the changes in the transient electrical resistance R, μmΩ depending on the type of lubricant, and curve V shows an example using a known contact lubricant (excluding intermetallic particles). Here, curve I reflects a one-month experiment with functional lubricant with 3% intermetallic particles included, respectively in the experiment with curve II functional lubricant was used in composition 5% intermetallic particles, curve III respectively 10%, curve IV-by 15%, and curve V is with a lubricant known from the prior art. When the contact surfaces are periodically heated as a result of electrical load or short-circuit currents, the intermetallic particles destroy the dielectric oxide layers on the contact surfaces and thus provide stabilization of the contact electrical resistance. The mechanism of layer destruction is based on the thermodynamic properties of the particles of the intermetallic compound with shape memory effect, which under the action of temperature change their shape, move relative to the contact surface, scratch the harmful layer and thus destroy the oxide films.

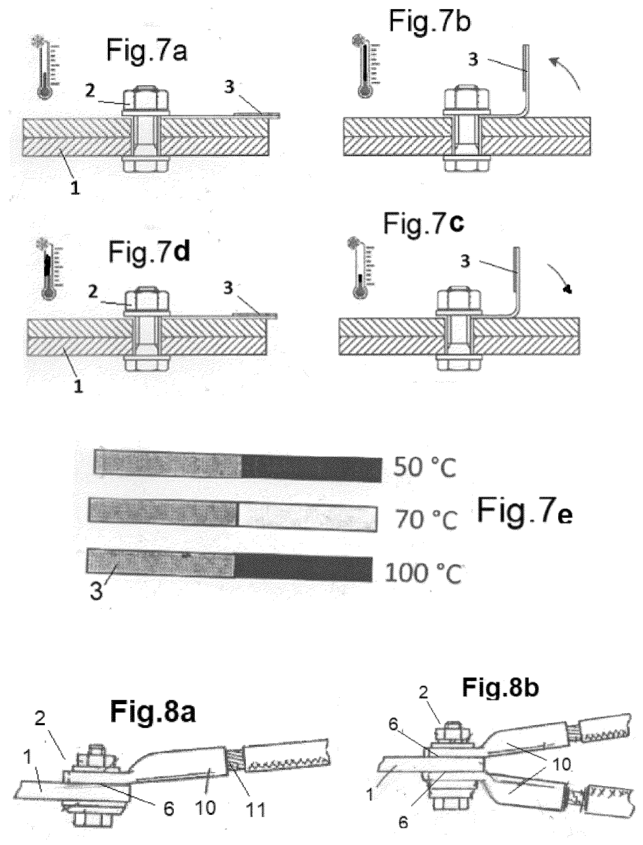

FIGS. 7a,b,c,d show the operation of the thermal indicator 3, and FIG. 7e shows marking with different colors of thermal indicators, activated at different threshold temperatures, for example at 50° C., 70° C., 100° C. The intermetallic thermal indicator 3 according to the invention in the case shown in FIGS. 7a,c is a plate of intermetallic material with a shape memory effect, having during installation an initial flat or angled shape at temperatures below the transformation temperature and as shown in FIGS. 7b,d—bending at an angle or upright shape at temperatures above the transformation temperature of the alloy. Any other form that can change when the threshold temperature is reached and the change can be registered is also suitable. Marked thermal indicators 3 without holes are shown, but they can also be with holes for mounting on the threaded element. The thermal indicators 3 can be made for different threshold temperatures, for example in the range 30-100° C. and are preferably mounted in direct contact with the threaded connection. Other values may be preferred depending on the needs, for example related to the electrical properties of the conductive elements and/or the climatic conditions of operation. As described above, the function of the thermal indicators is purely diagnostic and they are usually intended for multiple use. It is used to signal that a contact connection has a problem. In passive control, it is preferable to apply a color marking on the intermetallic thermal indicator, unified for different threshold temperatures. When the threshold temperature is reached, the intermetallic thermal indicator 3 regains its shape and fixes the fact of overheating of the contact connection (FIG. 7b,d), as the color marking assists the visual control. It is also possible to connect the thermal indicators to an automated control system (not shown in the drawings), for example to activate motion sensors or other applicable means.

FIGS. 8a,b show variants of connection by one or two cable lugs 10 attached to the cores of the cable 11. The functional contact lubricant 6 according to the invention is applied between the cable lugs 10 and the contact element 1, in this case as a flat terminal.

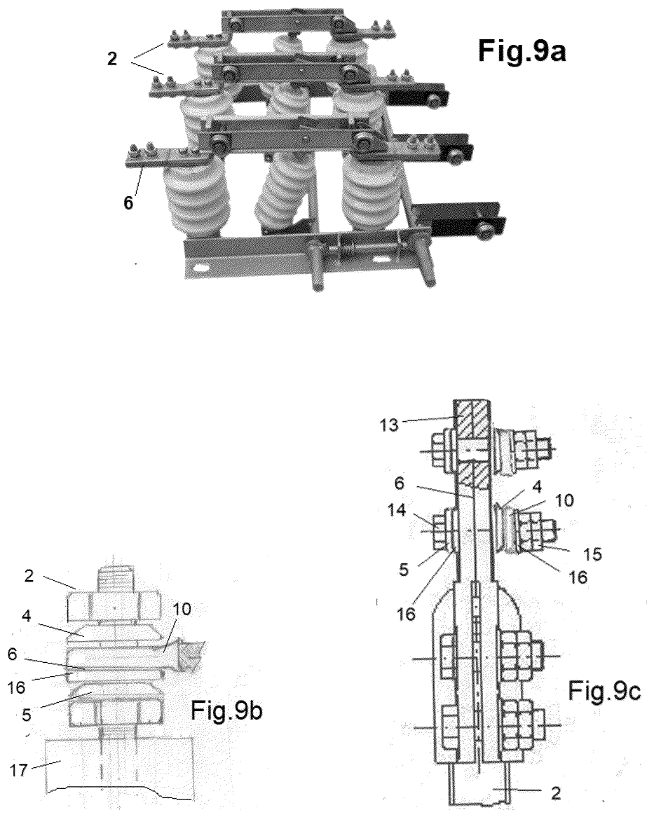

FIG. 9a shows an exemplary circuit diagram of a disconnector 12 for a power transformer with an integrated electrical contact connection according to the invention. Accordingly, FIGS. 9b,c show an integrated electrical contact connection according to the invention of a transformer without a contact clamp with only a cable lug 10. FIG. 9c shows a transformer with a contact clamp 13, with position 17 showing a ceramic insulator. The functional lubricant 6 is applied between the contact surfaces.

The method of stabilizing the contact resistance of the electrical contact connection, disclosed in the exemplary embodiment of FIG. 2a, includes first the steps of upbuilding the electrical contact connection. The steps are mounting in this case of two current-carrying elements 1 on the threaded element 14 of the bolted connection 2, mounting from one end of the threaded element 14 in contact with one current-carrying element 1 of contact pressure stabilizer 4 made of intermetallic with shape memory effect, pressing the electrical contact connection by winding and tightening a nut 15 on the threaded element 14, before mounting the current-carrying elements 1 on at least one of the contact surfaces of the conductive elements 1 are coated with an electrically conductive functional lubricant 6. The method in this case also comprises the step of mounting from the other end of the threaded element 14 with the possibility of contact with the other current-carrying element 1 of a spring intermetallic washer 5, made of an alloy with the effect of superelasticity. In this case, the method also comprises the step of mounting at least one thermal indicator 3 made of an alloy with a shape memory effect, positioned so as to be in contact with the elements of the contact connection which increase their temperature.

The method of stabilizing the contact resistance further comprises the step of scratching one or more contaminating layers formed during operation of the contact connection on the contact surfaces by using the lubricant 6 applied between the contact surfaces of the current-carrying elements 1 of the contact connection. The lubricant 6 is a mixture containing a plastic gel-lubricant 8 with added particles 9 made of alloy with shape memory effect, the microparticles 9 having a structure with at least one of sharp tips, regions or edges. The method further comprises the steps of regulating the tightening between the current-carrying elements 1 of the contact connection and maintaining a tight pressure to a nominal value in case of accidental or systematic reduction of the contact pressure and increase of the temperature of the contact connection by using a spring intermetallic washer 5 made of an alloy with the effect of superelasticity having the possibility to contact with one of current-carrying elements 1 and/or by using a contact pressure stabilizer made of an alloy with a shape memory effect having the possibility to contact with the other current-carrying element 1.

To confirm the effect of applying the contact compound according to the invention, a number of experimental studies have been carried out, and two examples have been selected which we consider to illustrate clearly the advantages of using the contact connection constructed with the elements of the provided mounting thermal stabilization kit.

### Example 1

This experiment is related to the study of the influence of the functional lubricant 6 of the invention on the operation of a known electrical contact compound. For the experiment, two sets, control and experimental, of detachable electrical contact connections were installed and subjected to long-term observation, whose busbars are made of aluminum because they are the most unstable. Each set of contact connection is 100 mm long and contains two current-carrying elements 1, being aluminum conductive rails with a thickness of 5 mm and a width of 50 mm, connected by a bolted detachable joint 2 of the prior art, whose elements are made of steel with a strength of 8.8, as follows: bolt M12 (DIN 933) 14, nut (DIN 934) 15 and two flat washers (DIN 7349) 16. The threaded connection of the two sets is tightened with a torque wrench (IntertoolXT-9003) at a tightening force of 40 Nm, as during of the experiment the contact pressure was not further corrected.

The contact surfaces of the control set are coated with electrical contact lubricant with trade name CIATIM 221, the thickness of the coating being 0.1 mm.

In the experimental set, the contact surfaces are coated with intermetallic electrically conductive lubricant 6, the thickness of the coating is also 0.1 mm. The lubricant is made on the basis of the same neutral contact lubricant for electrical contacts CIATIM 221 with included finely distributed powder of intermetallic particles 9 fraction 10-15 μm in an amount of 10.0% per unit mass and with a recovery temperature of the form 40° C.

TABLE 1

Transient electrical resistance R, μΩ

| | Experimental | Control |
|---|---|---|
| Measuring No | set - E | set - C |
| 1 | 13.15 | 27.38 |
| 2 | 13.28 | 27.93 |
| 3 | 13.73 | 32.87 |
| 4 | 13.96 | 34.47 |
| 5 | 14.10 | 39.15 |
| 6 | 14.35 | 43.87 |
| 7 | 14.51 | 51.65 |
| 8 | 14.80 | 57.21 |
| 9 | 14.92 | 63.93 |
| 10 | 15.05 | 72.11 |
| 11 | 15.34 | 87.26 |
| 12 | 15.70 | 115.03 |
| 13 | 15.93 | 147.30 |
| 14 | 16.28 | removed from |
| | | observation |
| 15 | 16.63 | |
| 16 | 17.05 | |
| 17 | 17.51 | |
| 18 | 17.80 | |
| 19 | 18.27 | |
| 20 | 19.31 | |
| 21 | 19.68 | |
| 22 | 20.05 | |
| 23 | 20.47 | |
| 24 | 20.15 | |
| 25 | 21.40 | |
| 26 | 21.26 | |

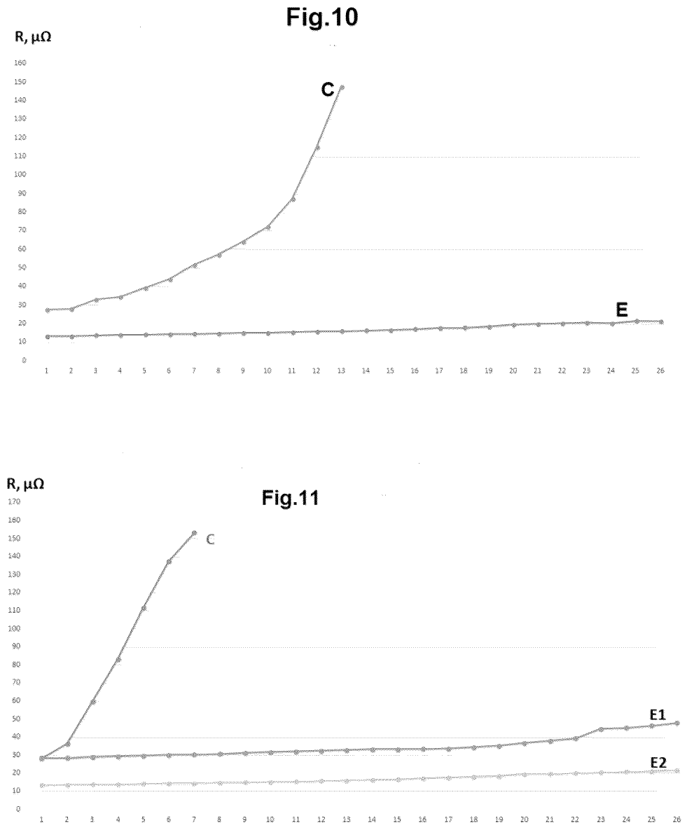

To evaluate the efficiency of using the functional lubricant according to the invention, tests were performed by measuring the transient contact resistance with a 084105 micrometer. The electrical contact joints are periodically subjected to forced heating to temperatures in the range of 90-120° C. for 45-300 minutes. The measurements were made after natural cooling to room temperature (20° C.) for 12 months at intervals of 20-30 days. The test results are given in Table 1 and are shown graphically in FIG. 10.

The results of this experiment show the following. In the first measurement, the transient electrical resistance of the experimental set E is 13.05 μΩ, which is 109% lower than that of the control set C—27.38 μΩ. This is due to the fact that the functional lubricant 6 according to the invention is a conductive lubricant due to the intermetallic particles involved and its use increases the effective area of the contact surfaces. In addition, during the 12 months of the experiment, the value of the contact resistance in experimental set E changed from 13.05 μΩ to 21.26 λΩ, while the contact resistance of control set C after the 12th measurement passed to a stage of uncontrolled growth of resistance and was removed from the experiment. In the experimental contact connection E with intermetallic lubricant, the process of increasing the transient resistance is quite slow, due to the presence of intermetallic particles of shape memory material in the lubricant, which destroy the formed oxide layers, stabilizing the transient electrical resistance. It can be seen that the normal service life of threaded electrical connections can be significantly extended, ensuring reliable operation of electrical equipment.

### Example 2

The experiment is related to the study of the complex influence of the elements of the contact compound of the invention in comparison with the operation of a conventional electrical contact connection. The program of the experiment and the experimental setup for its implementation were prepared in order to study the influence of cyclic “heating-cooling” on the technical condition of contact connections, their reliability, durability, not only from electrical parameters and time factor, but also depending on climatic conditions (fluctuations in temperature and humidity).

Three sets, one control C and two experimental E1 and E2, detachable electrical connections, whose busbars are made of aluminum because they are the most unstable, were installed and subjected to continuous monitoring. Each set of contact connections is 100 mm long and contains two aluminum conductive rails 1, each 10 mm thick and 40 mm wide, connected by a known bolted detachable joint, the elements of which are made of steel with a strength of 8.8, as follows: bolt M12 (DIN 933) reference 14, nut (DIN 934) reference 15 and two flat washers (DIN 7349) reference 16. The threaded joints of the all sets are tightened with a torque wrench (IntertoolXT-9003) at a tightening force of 40 Nm, as during of the experiment the contact pressure was not further corrected.

The contact surfaces of control set C and experimental set E1 are coated with the well-known silicone lubricant for electrical contacts with trade name HUSKEY 350 Silicone Grease, with a coating thickness of 0.1 mm.

The experimental set E1, in addition to the above-mentioned elements bolt 14, nut 15 and flat washers 16, contains in this case a contact pressure stabilizer 4 made of intermetallic material with shape memory effect with a mold recovery temperature of 40° C. The stabilizer 4 is made in the form of a disc washer with an inner diameter suitable for an M12 bolt.

The experimental set E2, in addition to the elements of the experimental set E1 with intermetallic stabilizer 4, also contains a functional intermetallic electrically conductive lubricant 6 of the invention, instead of the known silicone lubricant, covering the contact surfaces with a coating thickness of 0.1 mm. The lubricant is made on the basis of neutral contact lubricant 8 for electrical contacts, with trade name CIATIM 221, in which are evenly distributed powder of intermetallic particles 9 with a fraction of 10-15 μm in an amount of 10.0% per unit mass and with a recovery temperature of the form 40° C.

To evaluate the effectiveness of the simultaneous influence of the intermetallic stabilizer 4 and the functional lubricant 6 according to the invention, tests were performed for 13 months by measuring the transient contact resistance with a CS4105 micro ohmmeter. At intervals of 15 days, the electrical contact connections were periodically subjected to forced heating to temperatures in the range of 90-100° C. for 45-300 minutes and allowed to cool under natural conditions for 26 cycles. In the period between the measurements of the transient contact resistance, the experimental setup was left to the influence of street conditions—temperature range from −12° C. to +21° C., and the air humidity changed in the range 34-95%. The measurements of the transient contact resistance were made after the heating-cooling cycles in a laboratory at an ambient temperature of 17-23° C.

The test results are given in Table 2 and are shown graphically in FIG. 11.

TABLE 2

| | Transient electrical resistance, R (μΩ) | | |
|---|---|---|---|
| Measuring | Control | Experimental | Experimental |
| No | set C | set E1 | set E2 |
| 1 | 28.18 | 28.17 | 13.32 |
| 2 | 36.20 | 28.28 | 13.55 |
| 3 | 59.72 | 28.77 | 13.82 |
| 4 | 83.09 | 29.15 | 13.83 |
| 5 | 111.49 | 29.53 | 14.20 |
| 6 | 137.15 | 29.91 | 14.41 |
| 7 | 153.10 | 30.22 | 14.45 |
| 8 | removed from | 30.67 | 14.84 |
| | observation | | |
| 9 | | 31.15 | 14.95 |
| 10 | | 31.48 | 15.10 |
| 11 | | 31.90 | 15.42 |
| 12 | | 32.31 | 15.75 |
| 13 | | 32.68 | 15.90 |
| 14 | | 33.05 | 16.30 |
| 15 | | 33.24 | 16.52 |
| 16 | | 33.37 | 17.03 |
| 17 | | 33.65 | 17.45 |
| 18 | | 34.40 | 17.84 |
| 19 | | 35.11 | 18.30 |
| 20 | | 36.72 | 19.43 |
| 21 | | 37.80 | 19.72 |
| 22 | | 39.15 | 20.10 |
| 23 | | 44.53 | 20.35 |
| 24 | | 45.08 | 20.83 |
| 25 | | 46.20 | 21.06 |
| 26 | | 47.72 | 21.52 |

The results of this experiment show the following. In the first measurement, the transient electrical resistance of the control set C is 28.18 μΩ and of the experimental set E1 is 28.17 μΩ, which values are more than twice higher than the transient resistance of the experimental set E2-13.32 μΩ. This is due to the fact that the functional lubricant 6 according to the invention is a conductive lubricant and its use increases the effective area of the contact surfaces.

In control set C after the third cycle of “heating-cooling” a sharp increase of the transient resistance was found and after the seventh cycle at a measured transient resistance of 153.1 μΩ, the set was removed from observation.

In the experimental set E1 after 19 cycles of “heating-cooling” there is an increase in the transient resistance, which is explained by the burnout of the silicone contact lubricant HUSKEY 350 Silicone Grease and more intense formation of oxide layers.

The results of the transient resistance measurements in the experimental set E2, in which intermetallic lubricant 6 was added in addition to the intermetallic stabilizer 4, showed a stabilization of the transient resistance at levels below 22 μΩ throughout the 13-month experiment.

All physicochemical processes (effect of weakening of contact pressure due to cyclic thermal expansion-contraction; oxidation of contact surfaces with formation of oxide layers; reduction of the effective area of contact surfaces, aging of materials) occurred on the tested sets of Example 2 during the experiment. specific for the real operating conditions of the electrical contact connections built into electrical networks and equipment.

The test results confirmed the effect of the simultaneous use of intermetallic heat stabilizer 4 and intermetallic contact lubricant 6 in detachable electrical connections. The proposed contact electrical connection according to the invention protects both from the negative influence of the oxide dielectric films and from the weakening of the contact pressure force of the connection, wherein reliably protecting such connections from thermal decomposition. This ensures the reliability of the electrical equipment and repeatedly extends the service life in normal mode without the need for intervention by service personnel.

Although the description above contains many specifics, these should not be construed as limiting the scope of the invention but as merely providing illustrations of some of the presently preferred embodiments of this invention. Thus, the scope of this invention should be determined by the appended claims and their legal equivalents.

1. An electrical contact connection comprising at least two current-carrying elements having contact surfaces, at least one threaded joint having a threaded element and at least one nut for squeezing the contact surfaces of the current-carrying elements, comprising:
a lubricant for applying to the contact surface of at least one of the at least two current-carrying elements wherein
the lubricant is a mixture containing a plastic gel with added microparticles of an alloy with a shape memory effect and
the particles of alloy with shape memory effect added to the plastic gel have a structure with at least one of sharp tips, regions or edges.

2. The electrical contact connection according to claim 1, further comprising at least one contact pressure stabilizer made of an alloy with a shape memory effect capable of being positioned at one end of the threaded element and for contact with one current-carrying element.

3. The electrical contact connection according to claim 1, it further comprising a spring washer made of intermetallic alloy capable of being positioned at the other end of the threaded element and for contact with a contact surface of another current-carrying element, wherein the intermetallic alloy is with an effect of superelasticity.

4. The electrical contact connection according to claim 1, further comprising at least one temperature indicator made of an alloy with a shape memory effect, having the possibility of positioning and contact with the elements of the contact connection.

5. A lubricant for the electrical contact connection of claim 1, wherein the lubricant is a mixture of a plastic gel with added particles of an alloy with a shape memory effect, and the added particles of shape memory alloy have a structure with at least one of sharp tips, regions or edges.

6. The lubricant according to claim 5, wherein the amount of added particles of shape memory alloy is in the range of 7-15% and/or the particles size is about 10 μm.

7. The lubricant according to claim 6, wherein the particles size is about 10 μm.

8. The lubricant according to claim 6, wherein the plastic gel is a neutral or electrically conductive lubricant.

9. A kit of parts for the electrical contact connection of claim 1, comprising at least one threaded element, at least one nut, at least one contact pressure stabilizer and at least one item containing lubricant according to claim 6.

10. The kit of parts according to claim 9, further comprising at least one spring washer made of intermetallic alloy and/or at least one temperature indicator made of an alloy with a shape memory effect according to claim 4.

11. Transformer equipment, comprising at least one electrical contact connection according to claim 1.

12. An electrical contact network for railway and/or urban transport comprising at least one electrical contact connection according to claim 1.

13. A method of stabilizing the contact resistance of a detachable electrical contact connection comprising:
scratching one or more contaminating layers formed during operation of the contact connection on the contact surfaces by using a lubricant applied between the contact surfaces of the current-carrying elements of the contact connection;
wherein the lubricant is a mixture containing a plastic gel with added particles of an alloy with a shape memory effect and
the particles of alloy with shape memory effect added to the plastic gel have a structure with at least one of sharp tips, regions or edges for scratching and destruction of contaminating layers formed during the operation of the contact connection on the contact surfaces.

14. The method according to claim 13, further comprising regulating the tightening between the current-carrying elements of the contact connection and maintaining a tight pressure to a nominal value in case of accidental or systematic reduction of the contact pressure and increase of the temperature of the contact connection by using a spring intermetallic washer made of an alloy with the effect of superelasticity having the possibility to contact with one of current-carrying elements and/or by using a contact pressure stabilizer made of an alloy with a shape memory effect capable to contact with the other current-carrying element.
